(19) United States
(12) Patent Application Publication
(10) Pub. No.: US 2019/0038951 A1
(43) Pub. Date: Feb. 7, 2019

(54) Sports Bag Stand or Tennis Bag Stand

(71) Applicants: Danie Lee Curry, Mt. Pleasant, SC (US); Margie Ann Curry, Mt Pleasant, SC (US)

(72) Inventors: Danie Lee Curry, Mt. Pleasant, SC (US); Margie Ann Curry, Mt Pleasant, SC (US)

(21) Appl. No.: 15/669,043

(22) Filed: Aug. 4, 2017

(51) Int. Cl. A63B 71/00; F16M 11/38

(52) U.S. Cl. CPC A63B 71/0045; A63B 2210/50; F16M 11/38

(57) ABSTRACT

A sports bag stand or tennis bag stand designed to be attached to a tennis bag or other sports bag. The stand and bag are attached, preferably using bungee cords with balls, although it can be attached in other ways. There are at least two attachment points needed on the bag which could be a shoulder strap, backpack strap, grab handle, or other point on the object. The stand is generally rectangular in shape. The object attached to the top frame of the sports bag stand or tennis bag stand, is generally horizontally oriented. In the folded or closed position, the object attached to the stand, can be carried or stored. The mechanism for the legs enables them to pivotally move between the unfolded or open position, and the folded or closed position, and controls the range of motion for each leg. One leg of the stand extends out or is kicked out to provide additional stability to the structure.

### BACKGROUND OF THE INVENTION

The present invention generally relates to folding stands and sports bag stands. The sports bag stand or tennis bag stand of this invention is generally rectangular in shape, and designed to be attached to a tennis bag or other sports bag. The attached object is generally in a horizontal position, in the unfolded or open position. Folding stands have been popular for decades and are useful for transporting objects from one location to another.

In the game of tennis and other sports, players carry gear bags full of equipment and personal items to the tennis courts or playing field. When they arrive to play their favorite sport, they are forced to set their bags on the ground, or on tennis court benches or field benches, and there is no space for people to sit. This sports bag stand or tennis bag stand is useful because it addresses that issue, and also has pivoting legs that control the range of motion for the unfolded or open position, and the folded or closed position. Once a tennis bag or other sports bag is attached to the sports bag stand or tennis bag stand, it remains attached whether it is being used, carried, or stored. This sports bag stand or tennis bag stand is also useful because the object attached can be removed from the stand, and reattached to a different tennis bag or other sports bag.

### SUMMARY OF THE INVENTION

The first and preferred embodiment of the present invention comprises a sports bag stand or tennis bag stand for use with a horizontally oriented object such as a tennis bag or other sports bag, that is attached to the stand using bungee cords with balls or could be in other ways, wherein stand is capable of being manipulated between the unfolded or open position, and folded or closed position. In the unfolded or open position, the sports bag stand or tennis bag stand is generally rectangular in shape and the attached object is generally horizontally oriented. The object is attached to the top frame of the stand and there are pivoting legs with a range of motion for each leg. The offset leg or could be one leg or the stand, extends out or is kicked out past the end of the top frame and provides additional stability for the structure, when in the unfolded or open position.

To manipulate the sports bag stand or tennis bag stand into a folded or closed position, takes very little effort by the tennis player or sports enthusiasts. The legs are then secured by a bungee cord with ball that is on the top frame of the stand, and attaches to the stow leg or could be one leg of the stand. The folded or closed position is useful when carrying or storing the sports bag stand or tennis bag stand with the attached object.

The legs of the sports bag stand or tennis bag stand both pivot inward and overlap each other in the folded or closed position

This sports bag stand or tennis bag stand enables the attached tennis bag or other sports bag to set up off the ground in a generally horizontally position, when the stand is in the unfolded or open position.

### DESCRIPTION OF THE DRAWINGS

FIG. 1 is a perspective view of the first preferred embodiment shown of sports bag stand or tennis bag stand, for tennis bag or other sports bag, in the unfolded or open position.

FIG. 2 is an isometric view of the first preferred embodiment shown of sports bag stand or tennis bag stand, for tennis bag or other sports bag, in the unfolded or open position.

FIG. 3 is a front view of the first preferred embodiment shown of the sports bag stand or tennis bag stand, for tennis bag or other sports bag, in the unfolded or open position.

FIG. 4 is a right side view of the first preferred embodiment shown of the sports bag stand or tennis bag stand, for tennis bag or other sports bag, in the unfolded or open position.

FIG. 5 is a left side view of the first preferred embodiment shown of the sports bag stand or tennis bag stand, for tennis bag or other sports bag, in the unfolded or open position.

FIG. 6 is a back view of the first preferred embodiment shown of the sports stand or tennis bag stand, for tennis bag or other sports bag, in the unfolded or open position.

FIG. is a top view of the first preferred embodiment shown of the sports bag stand or tennis bag stand, for tennis bag or other sports bag, in the unfolded or open position.

FIG. 8 is a bottom view of the first preferred embodiment shown of the sports bag stand or tennis bag stand, for tennis bag or other sports bag, in the unfolded or open position.

FIG. 9 is an isometric view of the first preferred embodiment shown of the sports bag stand or tennis bag stand, for tennis bag or other sports bag, shown with attached object, and the stand in the unfolded or open position.

FIG. 10 is a front view of the first preferred embodiment shown of the sports bag stand or tennis bag stand, for tennis bag or other sports bag, shown with attached object, and the stand in the unfolded or open position.

FIG. 11 is a back view of the first preferred embodiment shown of the sports bag stand or tennis bag stand, for tennis bag or other sports bag, shown with attached object, and the stand in the unfolded or open position.

FIG. 12 is a right side view of the first preferred embodiment shown of the sports bag stand or tennis bag stand, for tennis bag or other sports bag, shown with attached object, and the stand in the unfolded or open position.

FIG. 13 is a left side view of the first preferred embodiment shown of the sports bag stand or tennis bag stand, for tennis bag or other sports bag, shown with attached object, and the stand in the unfolded or open position.

FIG. 14 is a top view of the first preferred embodiment shown of the sports bag stand or tennis bag stand, for tennis bag or other sports bag, shown with attached object, and the stand in the unfolded or open position.

FIG. 15 is a bottom view of the first preferred embodiment shown of the sports bag stand or tennis bag stand, for tennis bag or other sports bag, shown with attached object, and the stand in the unfolded or open position.

FIG. 16 is a bottom isometric view of the first preferred embodiment shown of the sports bag stand or tennis bag stand, for tennis or other sports bag, shown with attached object, and the stand in the unfolded or open position.

FIG. 17 is an isometric view of the first preferred embodiment shown of the sports bag stand or tennis bag stand, for tennis bag or other sports bag, in the folded or closed position.

FIG. 18 is a front view of the first preferred embodiment shown of the sports bag stand or tennis bag stand, for tennis bag or other sports bag, in the folded or closed position.

FIG. 19 is a right side view of the first preferred embodiment shown of the sports bag stand or tennis bag stand, for tennis bag or other sports bag, in the folded or closed position.

FIG. 20 is a left side view of the first preferred embodiment shown of the sports bag stand or tennis bag stand, for tennis bag or other sports bag, in the folded or closed position.

FIG. 21 is a back view of the first preferred embodiment shown of the sports bag stand or tennis bag stand, for tennis bag or other sports bag, in the folded or closed position.

FIG. 22 is a top view of the first preferred embodiment shown of the sports bag stand or tennis bag stand, for tennis bag or other sports bag, in the folded or closed position.

FIG. 23 is a bottom view of the first preferred embodiment shown of the sports bag stand or tennis bag stand, for tennis bag or other sports bag, in the folded or closed position.

FIG. 24 is an isometric view of the first preferred embodiment shown of the sports bag stand or tennis bag stand, for tennis bag or other sports bag, shown with the attached object, and the stand in the folded or closed position.

FIG. 25 is a front view of the first preferred embodiment shown of the sports bag stand or tennis bag stand, for tennis bag or other sports bag, shown with the attached object, and the stand in the folded or closed position.

FIG. 26 is a right side view of the first preferred embodiment shown of the sports bag stand or tennis bag stand, for tennis bag or other sports bag, shown with the attached object, and the stand in the folded or closed position.

FIG. 27 is a left side view of the first preferred embodiment shown of the sports bag stand or tennis bag stand, for tennis bag or other sports bag, shown with the attached object, and the stand in the folded or closed position.

FIG. 28 is a bottom isometric view of first preferred embodiment shown of the sports bag stand or tennis bag stand, for tennis bag or other sports bag, shown with the attached object, and the stand in the folded or closed position.

FIG. 29 is a back view of the first preferred embodiment shown of the sports bag stand or tennis bag stand, for tennis bag or other sports bag, shown with the attached object, and the stand in the folded or closed position.

FIG. 30 is a top view of the first preferred embodiment shown of the sports bag stand or tennis bag stand, for tennis bag or other sports bag, shown with the attached object, and the stand in the folded or closed position.

FIG. 31 is a bottom view of the first preferred embodiment shown of the sports bag stand or tennis bag stand, for tennis bag or other sports bag, shown with the attached object, and the stand in the folded or closed position.

FIG. 32 is a view of the first preferred embodiment shown of the sports bag stand or tennis bag stand, being carried by tennis player, with attached object, and the stand in the folded or closed position.

FIG. 33 is an exploded isometric view of the sports bag stand or tennis bag stand, for tennis bag or other sports bag.

FIG. 34A is an exploded isometric view of the pivot assembly for stow leg of the sports bag stand or tennis bag stand.

FIG. 34B is an exploded isometric view of the pivot assembly for offset leg of the sports bag stand or tennis bag stand.

FIG. 35A is an assembled view of pivot assembly for the sports bag stand or tennis bag stand.

FIG. 35B is a sectional view of pivot assembly for the sports bag stand or tennis bag stand.

FIG. 36 is a view of longer bungee cord with double knot and ball, shorter bungee with ball, and ball shown by itself.

### DETAILED DESCRIPTION

A tennis player or other sports enthusiast can set up and use this sports bag stand or tennis bag stand, in just a couple of minutes, which was invented to be used with the attached object which is a tennis bag or other sports bag. It takes very little effort to manipulate the pivoting legs of the stand from the folded or closed position, or the unfolded or open position. When a player is finished using the sports bag stand or tennis bag stand, it can be easily folded or closed, and is ready to be carried, using the shoulder strap, backpack strap, or grab handle of the attached object. In the folded or closed position, the stand can also be stored with the attached object, which is a tennis bag or other sports bag, until it is ready to be used again.

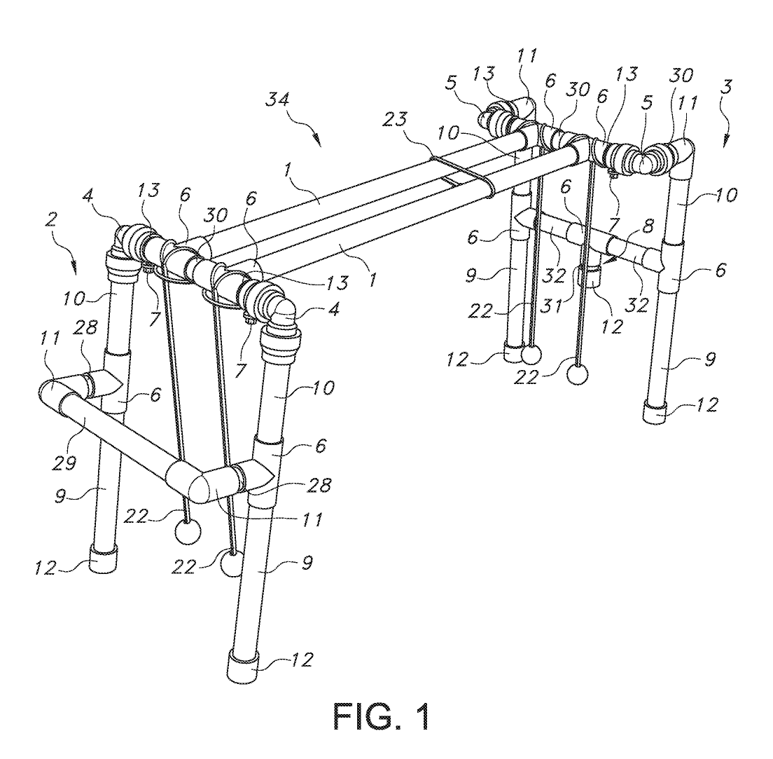

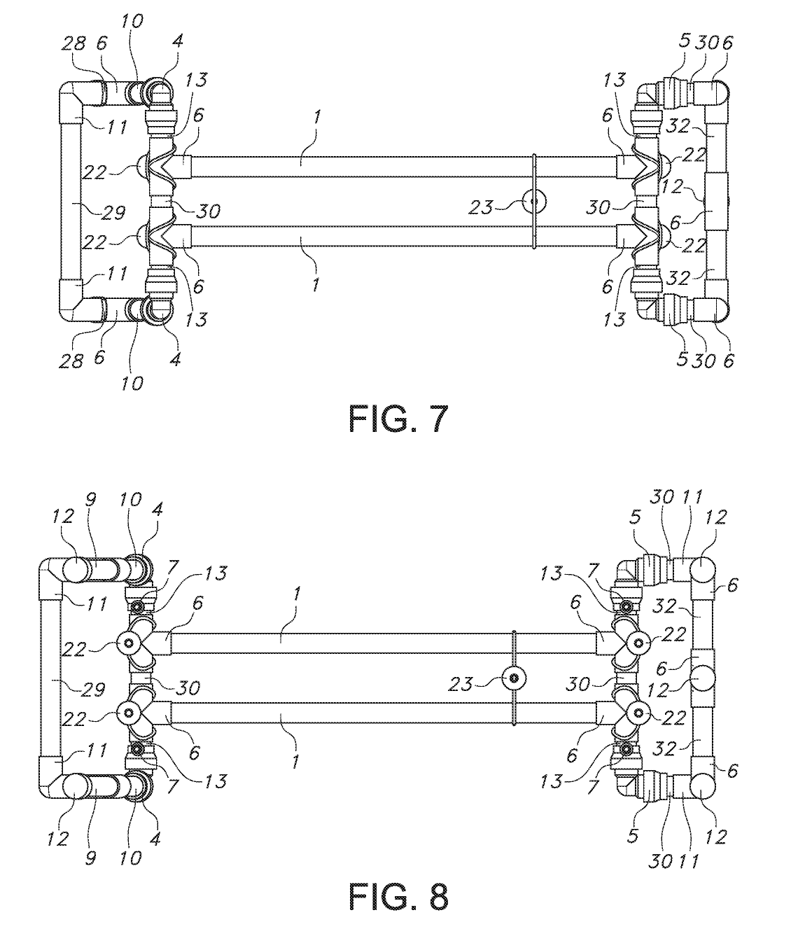

FIGS. 1-8 shows the first preferred embodiment of a sports bag stand or tennis bag stand 34 for use with tennis bag or other sports bag 26, shown in the unfolded or open position. The sports bag stand or tennis bag stand 34 has a top frame 1 which is comprised of two pieces, a pivoting offset leg 2, and a pivoting stow leg 3. The sports bag stand 34 has four longer bungee cords with balls 22 which are looped around the two top tee fittings 6 at each end of the pivoting offset leg 2 and pivoting stow leg 3, of the sports bag stand or tennis bag stand 34, and are used to attach the sports bag stand or tennis bag stand 34 to a tennis bag or other sports bag 26. A shorter bungee cord with ball 23 is located on the top frame 1 of the stand, towards the pivoting stow leg 3 end of the sports bag stand or tennis bag stand 34, and its purpose is to secure both legs when the stand is in the folded or closed position.

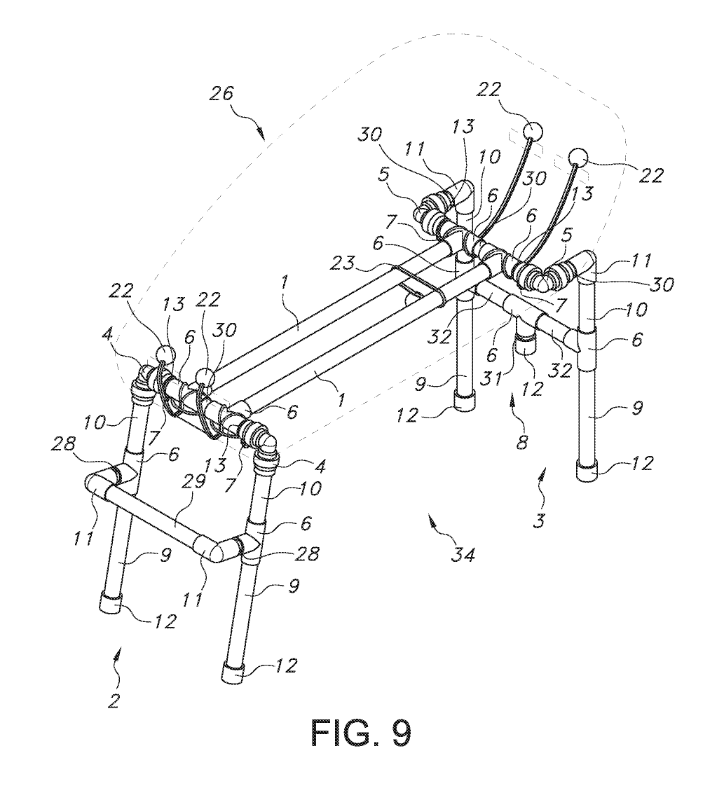

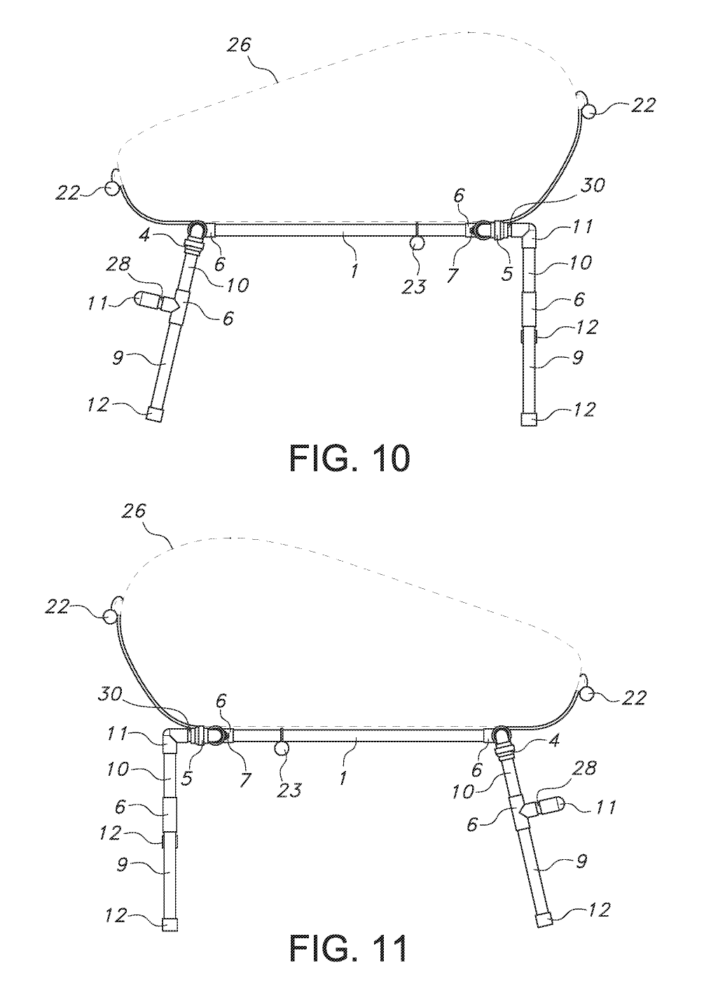

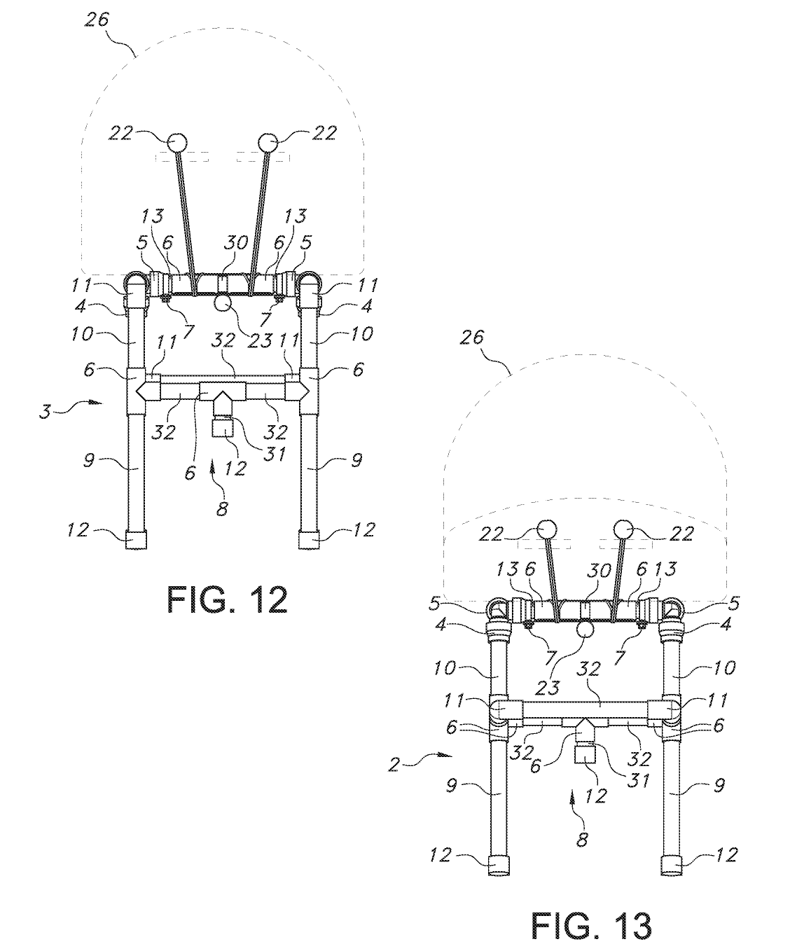

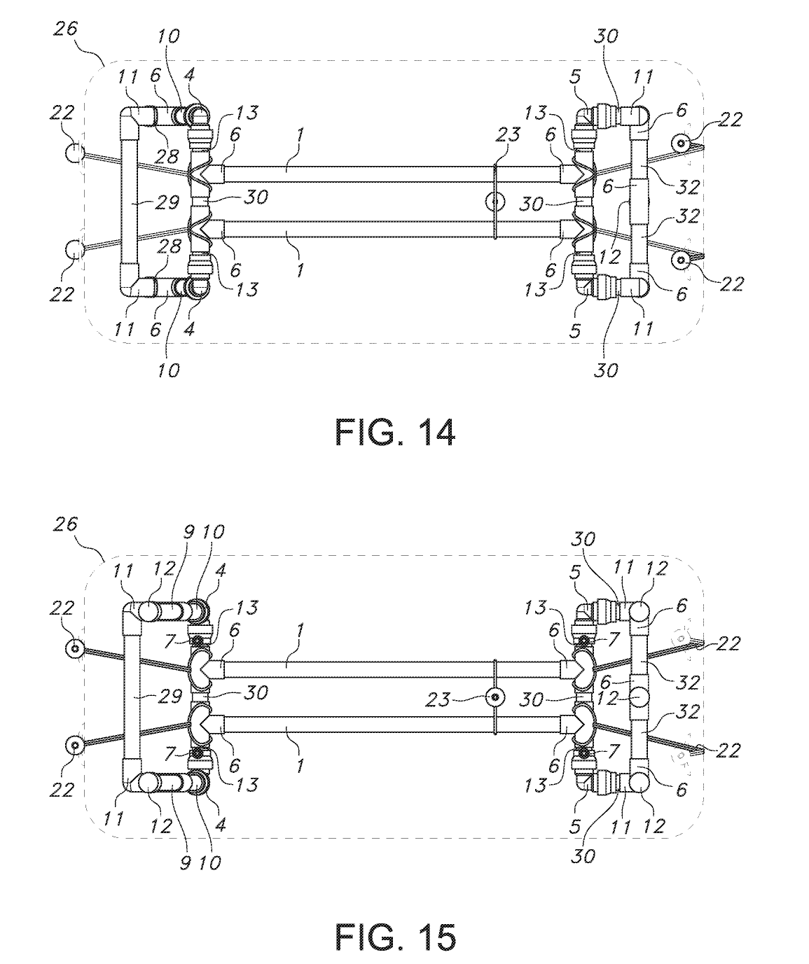

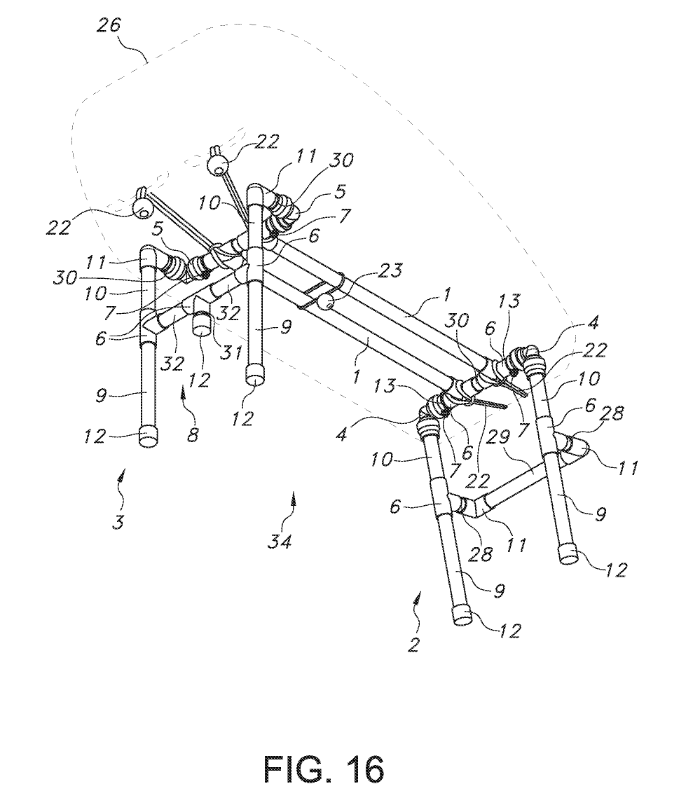

FIGS. 9-16 are drawings of the sports bag stand or tennis bag stand 34, shown with an object attached to the top frame 1. In these drawings the stand is in an unfolded or open position, with tennis bag or other sports bag 26 attached. The longer bungee cords with balls 22, are first attached to the pivoting offset leg 2 and pivoting stow leg 3. There are at least two attachment points on the bag needed to secure the tennis bag or other sports bag 26 to the sports bag stand or tennis bag stand 34, which can be a shoulder strap, backpack strap, grab handle, or could be other points on the object to attach the sports bag stand or tennis bag stand 34 and tennis bag or other sports bag 26 to each other. The stand and tennis bag or other sports bag 26, are attached to each other preferably by using bungee cords with balls, although it can be attached in other ways that are well known to those of ordinary skill in the art.

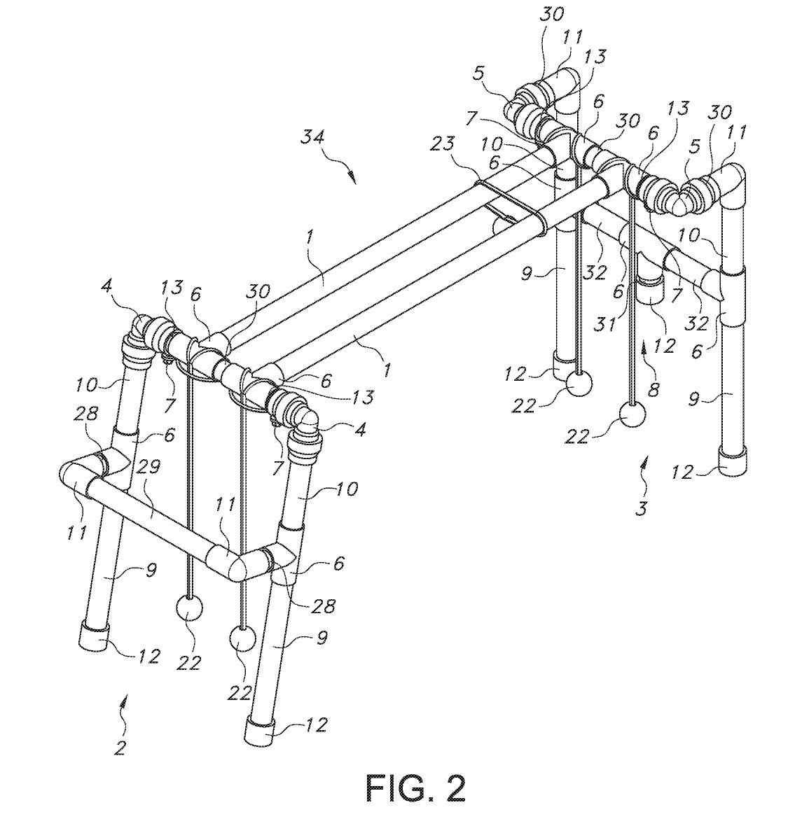

FIG. 2 shows the first preferred embodiment of the sports bag stand or tennis bag stand 34 for use with a tennis bag or other sports bag 26. In this drawing, the stand is in an unfolded or open position, and shows both the pivoting offset leg 2, and the pivoting stow leg 3.

FIG. 2 shows the top frame of the sports bag stand 1, which comprises two pieces, and has a shorter bungee cord with ball 23 attached to it.

FIG. 2 is a drawing of the pivoting offset leg 2, which comprises: a connector spacer 30, two tee fittings 6, which are located at the top of the pivoting offset leg 2, two longer bungee cords with balls 22, which are looped around both of the top tee fittings 6, two slotted pieces 13, two pivots for offset leg 4, two screws with washers 7, two upper leg pieces 10, two tee fittings 6, located between the upper leg pieces 10 and lower leg pieces 9, two spacers for offset leg 28, which are connected to two elbow fittings 11, offset leg crosspiece 29, two lower leg pieces 9, and two end caps 12.

FIG. 2 is a drawing of the pivoting stow leg 3, which comprises: a connector spacer 30, two tee fittings 6, which are located at the top of the pivoting stow leg 3, two longer bungee cords with balls 22, which are looped around both of the top tee fittings 6, two slotted pieces 13, two pivots for the stow leg 5, two screws with washers 7, two connector spacers 30, which are connected to two elbow fittings 11, two upper leg pieces 10, two tee fittings 6, located between the upper leg pieces 10 and lower leg pieces 9, connected to the two stow leg pieces 32, that are connected to a tee fitting 6 that has a spacer on stow leg 31, and a end cap 12, two lower leg pieces 9, and two end caps 12. Stow leg centerpiece 8 comprises: a tee fitting 6, spacer on stow leg 31, and end cap 12.

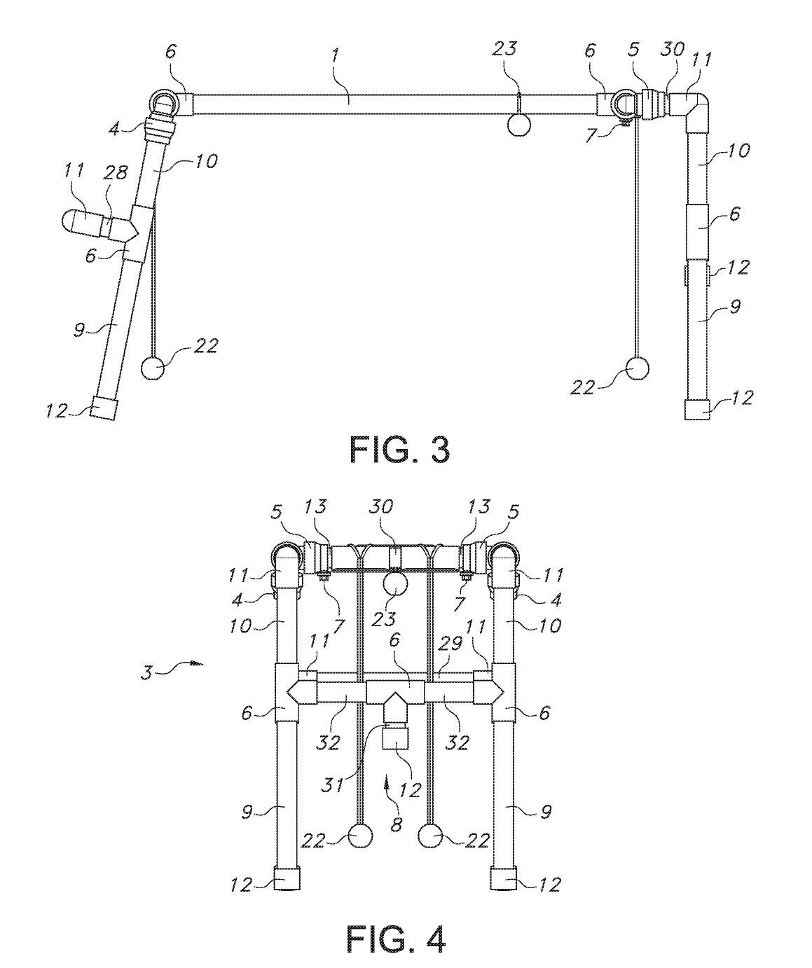

FIG. 3,6 shows the pivoting stow leg 3 which sets generally vertically at about a 90 degree angle, when the sports bag stand or tennis bag stand 34 is in the unfolded or open position. FIG. 4 shows the pivoting stow leg 3 in the unfolded or open position.

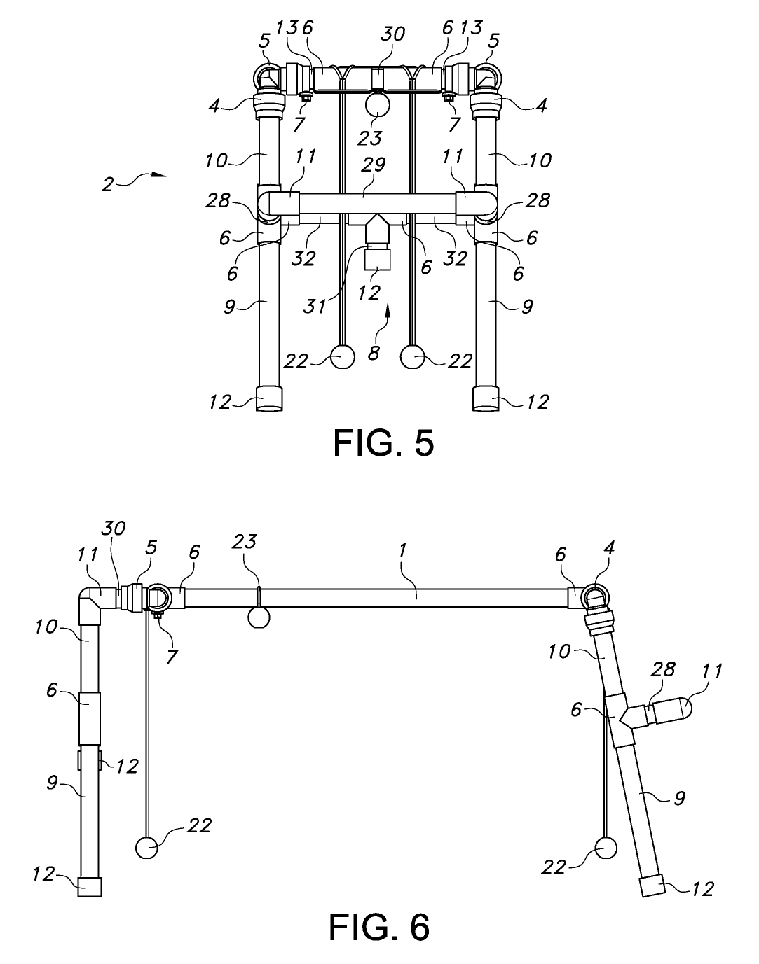

FIG. 3, 6 shows the pivoting offset leg 2 which extends out or is kicked out past the end of the top frame of the stand, to about a 110 degree angle, when the stand is in the unfolded or open position. FIG. 5 shows the pivoting offset leg 2 in the unfolded or open position.

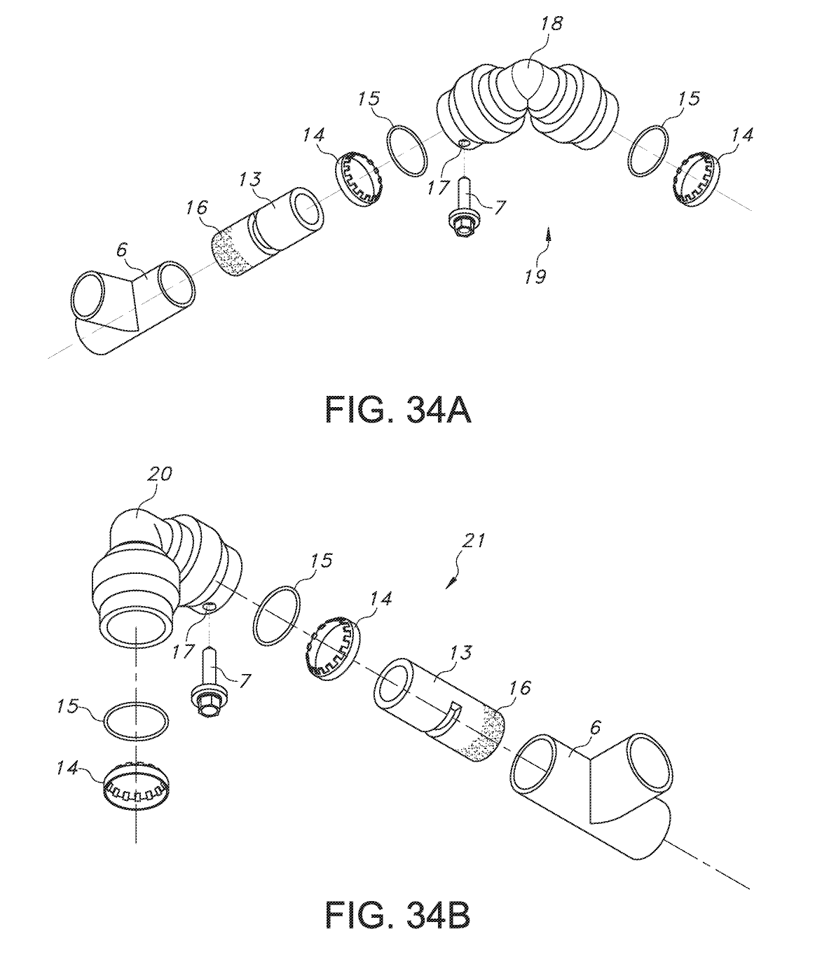

FIG. 34A, 34B, shows the mechanism for the legs of the sports bag stand or tennis bag stand 34, which enables them to pivotally move between the unfolded or open position and the folded or closed position.

FIG. 34A shows the pivot assembly for stow leg 19 and the range of motion for this leg. The range of motion is achieved by using a tee fitting 6, a slotted piece 13, and pivot for stow leg 5. The pivot for the stow leg 5 comprises: a pivot elbow housing 18, two o rings 15, and two slip rings 14. There is a drilled hole 17 towards one end of the pivot on the stow leg, a slotted piece 13 is inserted into the pivot on stow leg 5 and rotated to align with drilled hole 17. Screw with washer 7 is inserted into the drilled hole 17 and through the slotted piece 13. One end of the tee fitting 6 is pushed into the other end of the slotted piece 13 and is held in place with PVC cement 16. The range of motion is set by the screw with washer 7, which acts as a stop, based on the depth of the cut into the slotted piece 13.

FIG. 34B provides a good illustration of the pivot assembly for offset leg 21 and the range of motion for this leg. The range of motion is achieved by using a tee fitting 6, a slotted piece 13, and pivot for offset leg 4. The pivot for the offset leg 4 comprises: a pivot elbow housing 20, two o rings 15, and two slip rings 14. There is a drilled hole 17 towards one end of the pivot on the offset leg, a slotted piece 13 is inserted into the pivot on offset leg 4 and rotated to align with drilled hole 17. Screw with washer 7 is inserted into the drilled hole 17 and through the slotted piece 13. One end of the tee fitting 6 is pushed into the other end of the slotted piece 13 and is held in place with PVC cement 16. The range of motion is set by the screw with washer 7, which acts as a stop based on depth of the cut into the slotted piece 13.

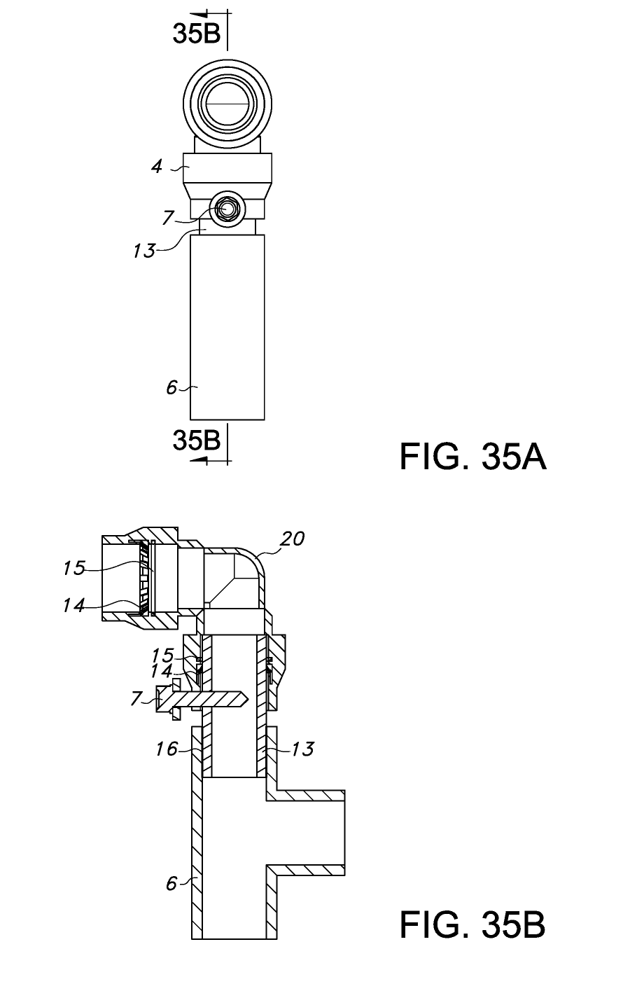

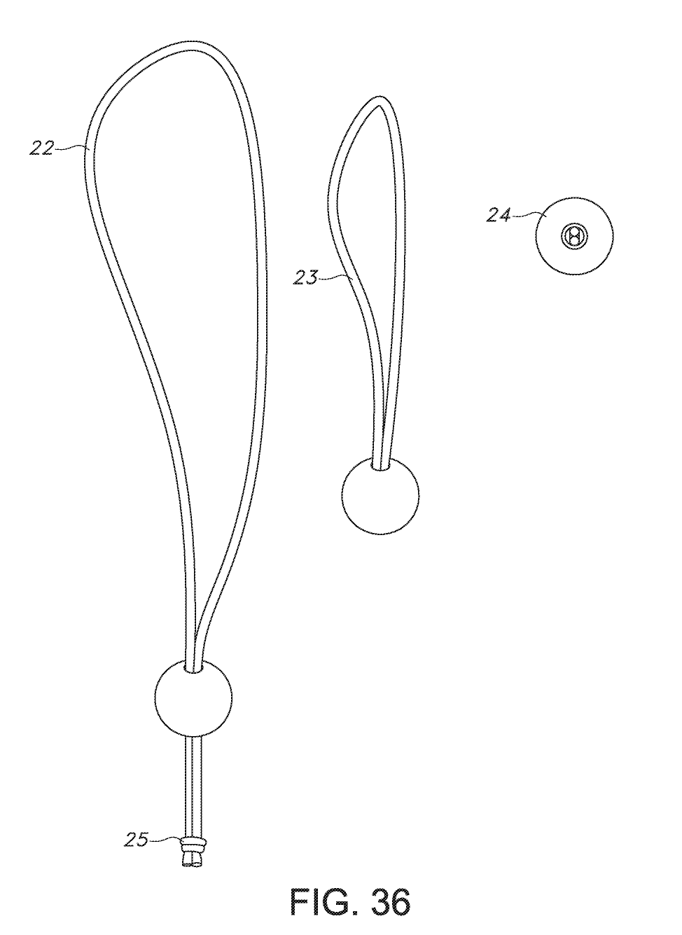

FIG. 35A is an assembled view of pivot assembly for offset leg 21. The pivot assembly for the offset leg comprises: a pivot for offset leg 4, screw and washer 7, slotted piece 23, and tee fitting 6. The function of these pivots is the same for both the stow leg 19 and offset leg 21, although only offset leg is depicted in drawing. The same components are used in the pivot assembly for stow leg 19 and pivot assembly for offset leg 21. The differences in these pivot assemblies for the two legs would be the positioning of the slotted piece 13 and where the PVC cement 16 is used to hold the slotted piece 13 in place on the tee fitting 6, and where the drilled holes 17 are located on the pivot elbow housing for stow leg 18 and pivot elbow housing for offset leg 20.

FIG. 35B is a sectional view of the pivot assembly for offset leg 21. The components shown in this sectional view comprises: a pivot elbow housing for offset leg 20, two o rings 15, two slip rings 14, screw with washer 7, and a tee fitting 6. The function of these pivots is the same for both the offset leg 21 and stow leg 19, although only offset leg is depicted in this drawing. The same components are used in the pivot assembly for stow leg 19 and pivot assembly for offset leg 21. The differences in these pivot assemblies for the two legs would be the positioning of the slotted piece 13 and where the PVC cement 16 is used to hold the slotted piece 13 in place on the tee fitting 6, and where the drilled holes 17 are located on the pivot elbow housing for stow leg 18 and pivot elbow housing for offset leg 20.

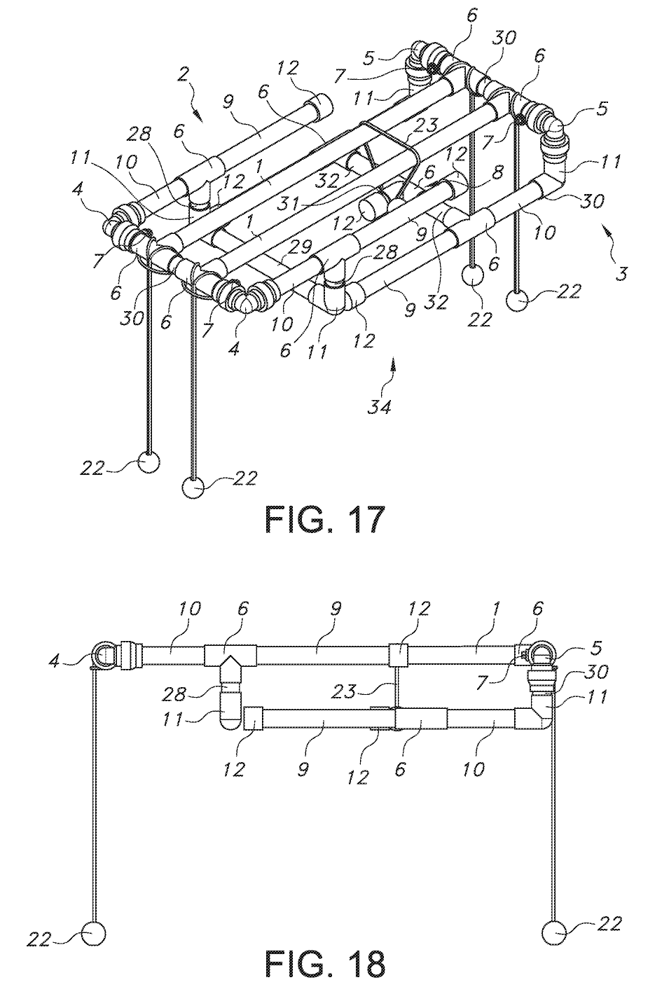

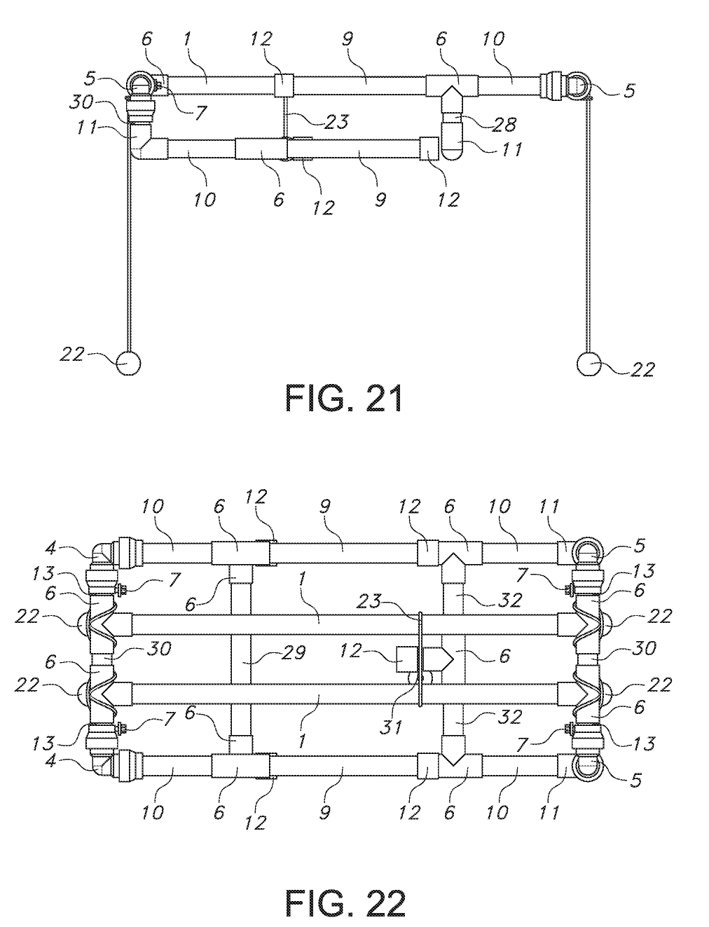

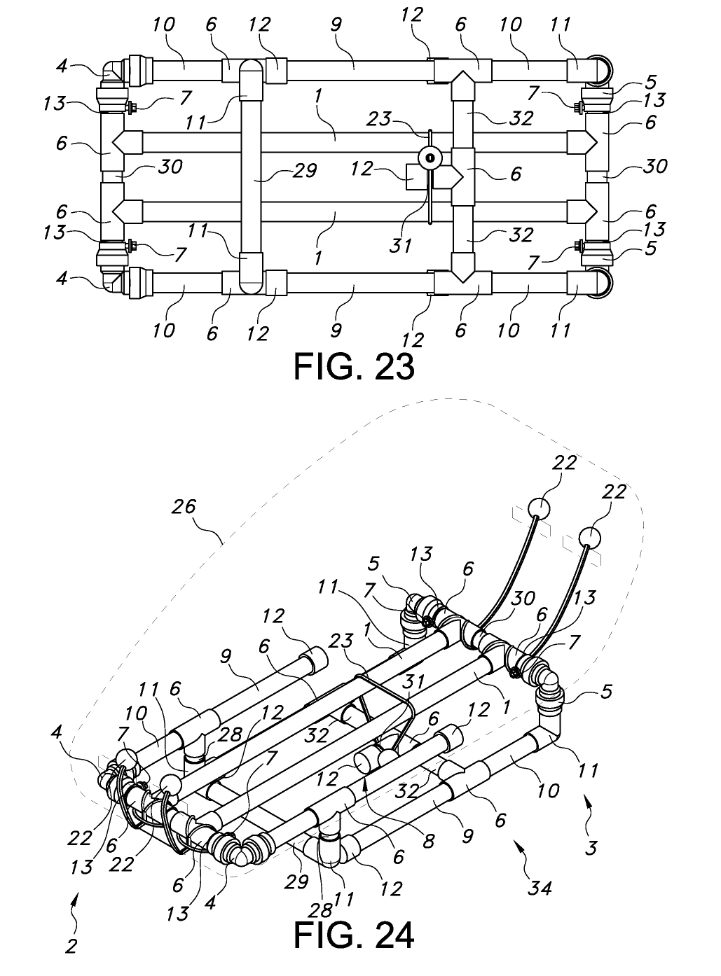

FIGS. 17-23 shows the sports bag stand or tennis bag stand 34 in the first preferred embodiment, with the stand in the folded or closed position. To manipulate the legs into the folded or closed position, takes very little effort by the tennis player or sports enthusiasts. First the pivoting offset leg 2 is folded inward. Next, the pivoting stow leg 3 is folded inward. When both legs of the sports bag stand or tennis bag stand 34 are in a folded or closed position, they will be overlapping each other, and will be secured with a shorter bungee cord with ball 23. The shorter bungee cord with ball 23 is looped around the two pieces of the top frame of the sports bag stand 1, and are stretched and secured onto the stow leg centerpiece 8.

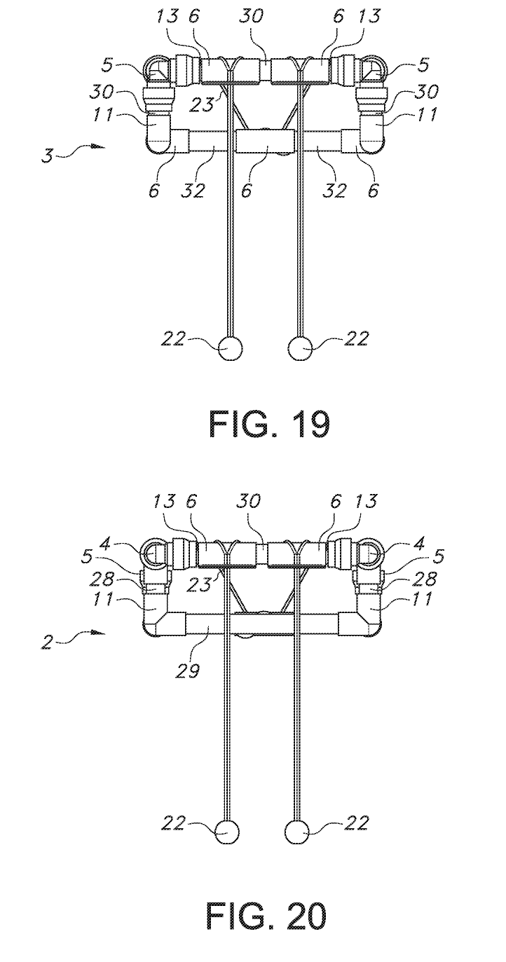

FIG. 19 is a drawing of the pivoting stow leg 3 in the folded or closed position, with shorter bungee cord with ball 23, attached to the two pieces of the top frame of sports bag stand 1, and secured at stow leg centerpiece 8. To unfold or open the legs of the stand, first you release the shorter bungee cord with ball 23 from the stow leg centerpiece 8, then grab the centerpiece, and pull it to the unfolded or open position. FIG. 20 is a drawing of the pivoting offset leg 2. To unfold or open this leg, grab the offset leg crosspiece 29 and pull it out to the unfolded or open position. For the sports bag stand or tennis bag stand to be in the correct set up position, the pivoting stow leg 3 should be generally vertical at about a 90 degree angle. The pivoting offset leg 2 should be extended or kicked out past the end of the top frame of the stand to about 110 degrees, as shown in FIGS. 1, 2, 3, and 6.

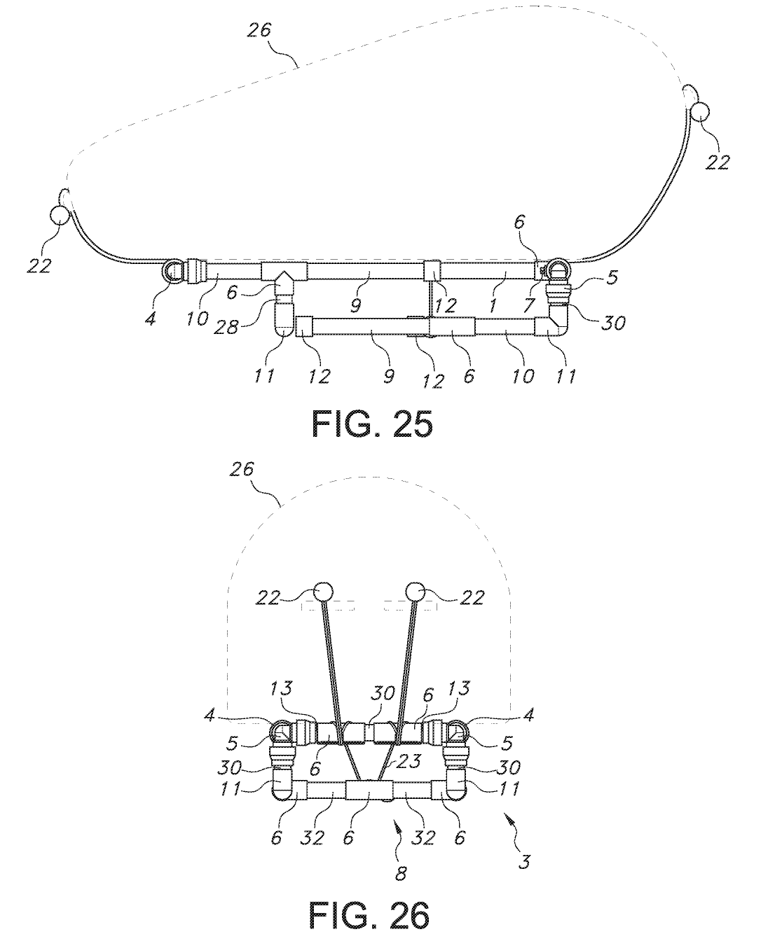

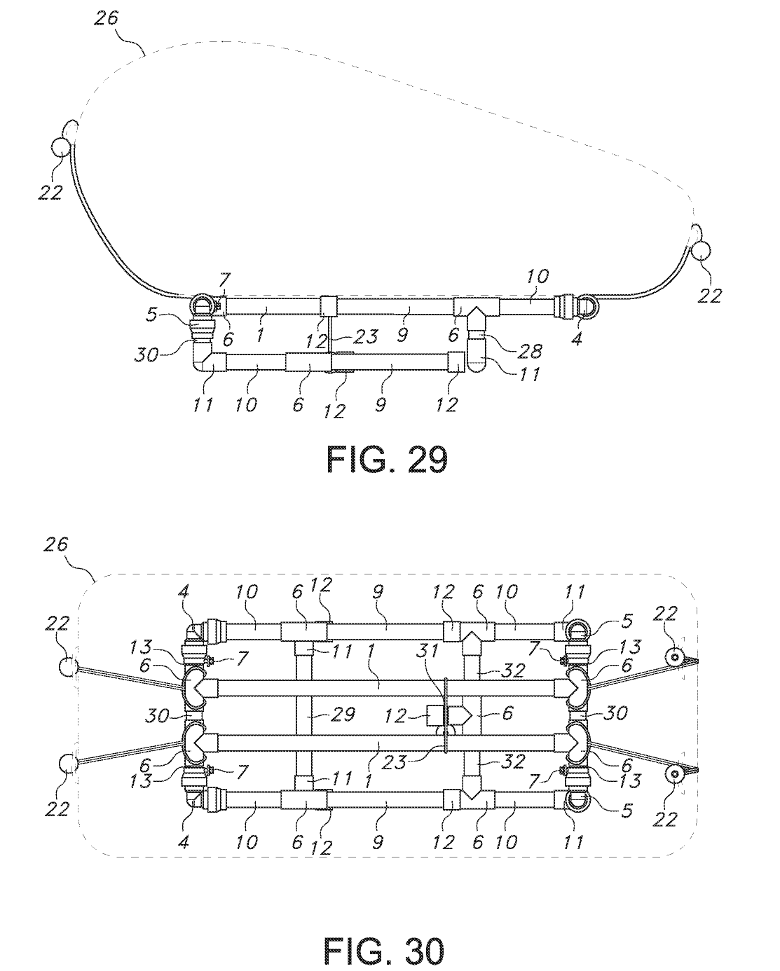

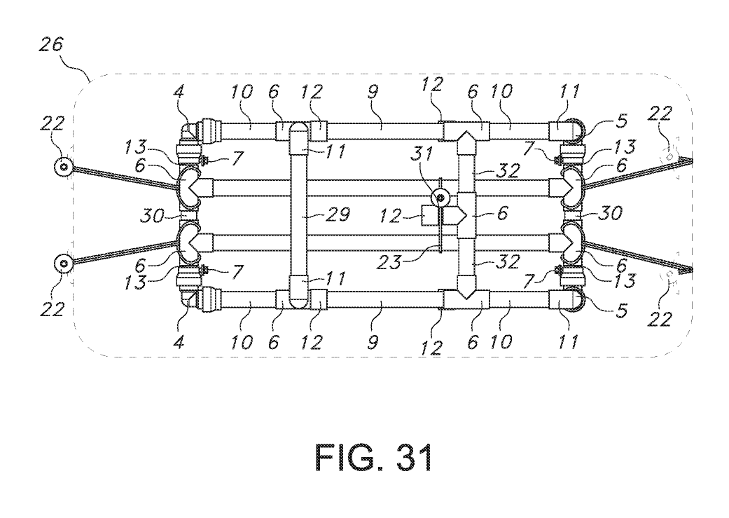

FIGS. 24-31 is a drawing of the sports bag stand 34 in a folded or closed position, with a tennis bag or other sports bag 26 attached to the stand. The attached object sets in a generally horizontal position.

FIG. 26, 28, 31 shows the pivoting stow leg 3 attached to the larger end of the tennis bag or other sports bag 26. Two longer bungee cords with balls 22 are attached to the two tee fittings 6 on the top of the pivoting stow leg 3, by looping them around the tee fittings 6, stretching them, and securing the longer bungee cords with balls 22, to an attachment point on the bag which could be a shoulder strap, backpack strap, grab handle, or other attachment points on the tennis bag or other sports bag 26. A shorter bungee cord with ball 23 is looped around the two pieces of the top frame of the stand 1 and the shorter bungee with ball 23, is stretched to attach it to the stow leg centerpiece 8.

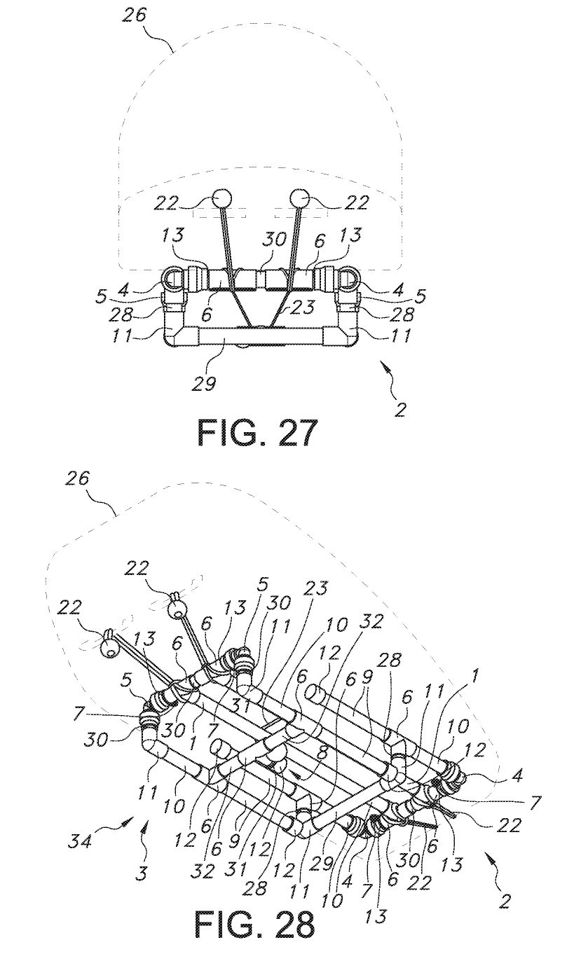

FIG. 27, 31 shows the pivoting offset leg 2 attached to the smaller end of the tennis bag or other sports bag. Two longer bungee cords with balls 22 are attached to the two tee fittings 6 on the top of the pivoting offset leg 2, by looping them around the tee fittings 6, stretching them, and securing the longer bungee cords with balls 22 to an attachment point on the bag which could be a shoulder strap, backpack strap, grab handle, or other attachment point on the tennis bag or other sports bag 26.

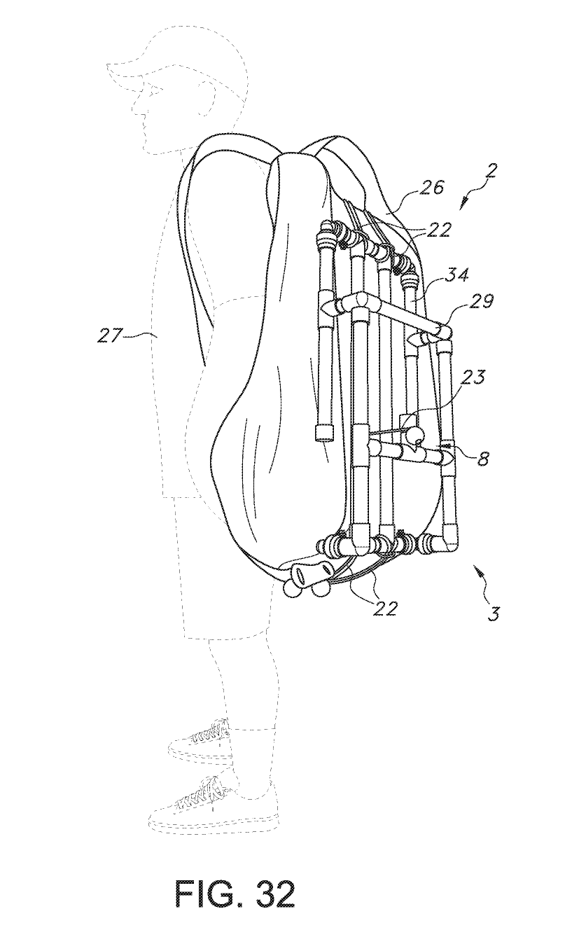

FIG. 32 is a drawing of a tennis player 27, carrying the sports bag stand or tennis bag stand 34, attached to a tennis bag or other sports bag 26, with the stand in the folded or closed position. This illustrates how the pivoting offset leg 2 and pivoting stow leg 3, are secured by using the shorter bungee cord with ball 23, which is stretched over to the stow leg centerpiece 8. Four longer bungee cords with balls 22 are attached to the ends of the tennis bag or other sports bag 26. The attachment points on the tennis bag or other sports bag 26 could be a shoulder strap, backpack strap, grab handle, or other points on the object to attach the tennis bag or other sports bag 26, and the sports bag stand 34 or tennis bag stand to each other.

FIG. 36 is a drawing of the longer bungee cord with ball 22, the shorter bungee cord with ball 23, bungee ball 24, and the double knot 25. The double knot is only visible on the longer bungee cord with ball 22, because the bungee ball is not pushed down to the end of the cord on the shorter bungee cord with ball 23. Bungee cords with balls are used to attach the sports bag stand or tennis bag stand 34 to the tennis bag or other sports bag 26, although it can be attached in other ways that are well known to those of ordinary skill in the art.

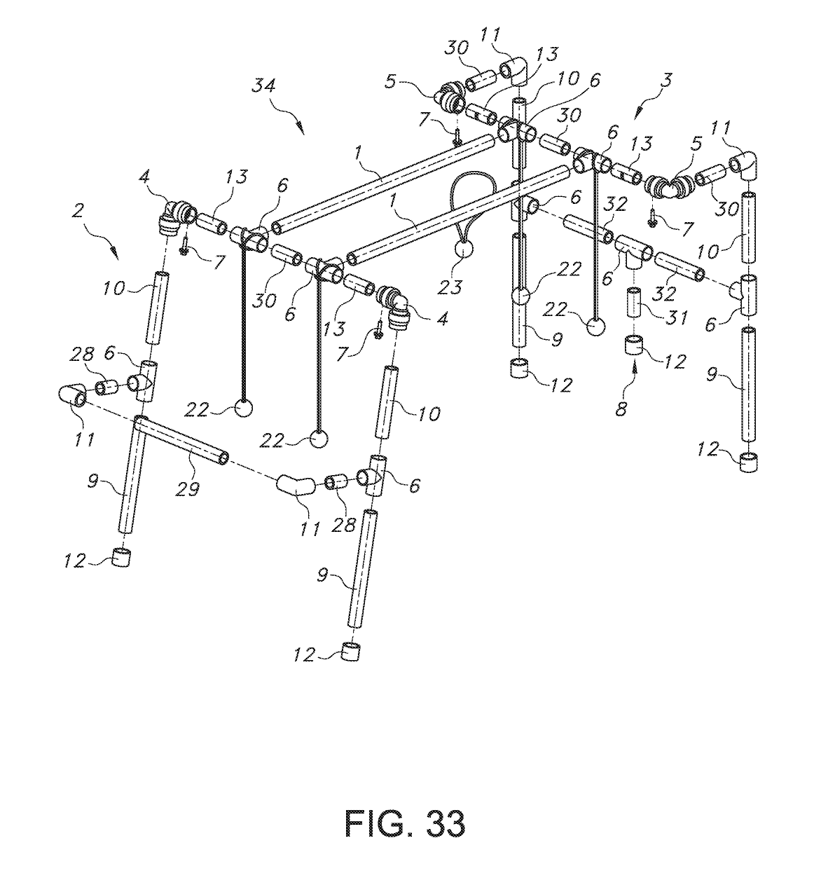

FIG. 33 is an exploded view of the sports bag stand or tennis bag stand 34. The top frame of stand comprises two pieces 1. There is a shorter bungee cord with ball 23 which is looped around the two pieces of the top frame of the stand 1. The pivoting offset leg 2 comprises: connector spacer 30, two tee fittings 6, located on the top of pivoting offset leg 2, two longer bungee cords with balls 22, two slotted pieces 13, two pivots for offset leg 4, two screws with washers 7, two upper leg pieces 10, two tee fittings 6, located between the upper leg piece 10 and lower leg piece 9, two spacers on offset leg 28, two elbow fittings 11, offset leg crosspiece 29, two lower leg pieces 9, and two end caps 12. The pivoting stow leg 3 comprises: connector spacer 30, two tee fittings 6, located on the top of the pivoting stow leg 3, two longer bungee cords with balls 22, two slotted pieces 13, two pivots for stow leg 5, two screws with washers 7, two connector spacers 30, two elbow fittings 11, two upper leg pieces 10, two tee fittings 6, located between the upper leg pieces 10 and lower leg pieces 9, two stow leg pieces 32, tee fitting 6, located at the center of the stow leg, spacer on stow leg 31, end cap 12, two lower leg pieces 9, and two end caps 12. The stow leg centerpiece 8 comprises: tee fitting 6, spacer on stow leg 31, and end cap 12.

FIG. 33 is an exploded view of all the components which comprise the sports bag stand or tennis bag stand 34. The first embodiment of the sports bag stand or tennis bag stand 34 has been constructed from PVC material, PVC fittings, screws with washers, and bungee cords with balls. The sports bag stand or tennis bag stand 34, could also be constructed from carbon fiber, polypropylene, or other plastic material, graphite, aluminum, or other steel material, fiberglass, or other material, or in other ways that are well known to those of ordinary skill in the art. The components of the sports bag stand 34 are held together using PVC cement 16 and screws with washers 7, although it also could be held together in other ways that are well known to those of ordinary skill in the art. The sports bag stand or tennis bag stand 34 is attached to a tennis bag or other sports bag 26, preferably using bungee cords with balls, although it could be attached using elastic cord, paracord, shock cord, rubber, toggle balls, gator clips, shark bite clips, or other ways that are well known to those of ordinary skill in the art.

1. A sports bag stand or could be tennis bag stand, with pivoting legs, which was designed to be attached to a tennis bag or could be other sports bag, thereto, said stand can be manipulated between unfolded or open position, and folded or closed position, wherein the object attached to the said stand is generally horizontally oriented in both the unfolded or open position and folded or closed position. A stand comprising a top frame having a generally horizontal configuration to have the object secured thereto, at least one pivoting leg that is generally vertical in the unfolded or open position, and is generally horizontal in the folded or closed position, and said stand that is attached to tennis bag or could be other sports bag, preferably by using bungee cords with balls, although it can be attached in other ways. The bungee cords with balls used to attach the tennis bag or could be other sports bag, to the stand are first attached to the top of both legs at the tee fittings. There are at least two attachment points on the bag needed to secure the tennis bag or could be other sports bag to the said stand, which can be a shoulder strap, backpack strap, grab handle, or could be other points on the object to attach stand and bag together. There is another bungee cord with ball that is looped around the two pieces of the top frame of the stand and stretched over to the stow leg or could be leg of the stand, to secure both legs, when the stand is in the folded or closed position. The stand with pivoting legs could be constructed from PVC, carbon fiber, polypropylene, or could be other plastic material, graphite, aluminum, or could be other steel material, fiberglass, or other material, although the sports bag stand or could be tennis bag stand, could be constructed in other ways. The components of the stand are held together with screws and PVC cement, although they could be held together in other ways. The stand is generally rectangular in shape and has folding legs.

2. A stand as defined in claim 1, wherein the said stand is a sports bag stand.

3. A stand as defined in claim 1, wherein the said stand is a tennis bag stand.

4. A stand as defined in claim 1 wherein the attached object is a tennis bag or could be other sports bag.

5. A stand as defined in claim 1 wherein it could be constructed from PVC, carbon fiber, polypropylene, or could be other plastic material, aluminum or could be other steel material, graphite, fiberglass, or could be other material, although the sports bag stand or tennis bag stand could be constructed in other ways. The components of the sports bag stand or could be tennis bag stand are held together with screws and PVC cement, although they could be held together in other ways.

6. A stand as defined in claim 1, wherein the stand is generally rectangular in shape.

7. A stand as defined in claim 1, attached to a tennis bag or could be other sports bag, with a pivoting mechanism for the folding legs, enabling the legs to be unfolded or open when using, and manipulated into a folded or closed position when carrying or storing.

8. A stand as defined in claim 1 that can be attached to a tennis bag or could be other sports bag, and can be removed from that object and reattached to another bag.

9. A stand as defined in claim 1, which is attached to a tennis bag.

10. A stand as defined in claim 1, wherein the stand is attached to a sports bag.

11. A stand as defined in claim 1 that attaches to a tennis bag or could be other sports bag, preferably using bungee cords with balls, although it can be attached in other ways.

12. A stand as defined in claim 1 that attaches to a tennis bag or could be other sports bag, using bungee cords with balls, elastic cord, paracord, shock cord, rubber, toggle balls, gator clips, or shark bite clips, although the sports bag stand and tennis bag or could be other sports bag could be attached in other ways.

13. The sports bag stand or could be tennis bag stand that attaches to a tennis bag or could be other sports bag, has a pivoting mechanism for the folding legs of the stand. This mechanism enables them to pivotally move between the folded or closed position, and the unfolded or open position. There is at least one pivot on each leg that controls the range of motion of the leg when the sports bag stand is in an unfolded or open position and folded or closed position. The pivoting offset leg or could be one leg of the sports bag stand, extends out or is kicked out past the end of the top frame of the stand, to about a 110 degree angle, when the stand is in the unfolded or open position. The pivoting offset leg or could be at least one leg of the sports bag stand, has a pivot comprising: at least one elbow fitting turned in a generally vertical position at about a 110 degree angle, and is connected to a leg of the sports bag stand, a slotted piece, a screw or could be other fastener, and a tee fitting or could be another type fitting. The pivoting stow leg, or could be at least one leg of the stand, has a pivot comprising: at least one elbow fitting turned in a generally horizontal position and connected to this leg of the stand which sets generally vertical at about a 90 degree angle, when it is in the unfolded or open position, and bungee cord with ball is looped around the top frame of the stand and is stretched to attach it to centerpiece on the pivoting stow leg or could be at least one leg of the stand, to secure both legs when the stand is in a folded or closed position, a slotted piece, a screw or other fastener, and a tee fitting or could be another type fitting. The stand has folding legs, which are designed to pivot inward and overlap each other in the folded or closed position. When the stand is in the unfolded or open position, the design of the legs helps to achieve the desired height of the stand.

14. The mechanism for the legs of the stand, as defined in claim 13, enables them to pivotally move between the unfolded or open position, and folded or closed position, and controls the range of motion of each leg.

15. There is at least one pivot on each leg of stand, as defined in claim 13, that controls the range of motion of the leg, when the said stand is in the unfolded or open position and the folded or closed position.

16. The pivoting offset leg or could be leg of the stand as defined in claim 13, when in the unfolded or open position, extends out or is kicked out past the end of the top frame of the stand.

17. The pivoting stow leg or could be leg of the stand, as defined in claim 13, has a bungee cord with ball looped around the top frame of the stand and is stretched to attach it to the centerpiece on the pivoting stow leg or could be one of the leg of the stand, to secure both legs, when it is in the folded or closed position.

18. The legs of the stand as defined in claim 13 are secured when in the folded or closed position, for carrying or storing said stand and attached object, which is a tennis bag or could be other sports bag.

19. The legs of the stand as defined in claim 13, are designed to pivot inward and overlap each other in the folded or closed position, for carrying and storing.

20. The sports bag stand or could be tennis bag stand, which is attached to a tennis bag or could be other sports bag, enables the attached object to set up off the ground in a generally horizontal position when said stand is in the unfolded or open position.
